(19) United States
(12) Patent Application Publication
(10) Pub. No.: US 2014/0236834 A1
(43) Pub. Date: Aug. 21, 2014

(54) METHODS, USES AND SYSTEM FOR TRANSMITTING, CONVERTING, AND DISPLAYING A CHALLENGE TOKEN AS AN OPTICALLY READABLE CODE

(71) Applicant: Neil Appalsamy, Ajax (CA)

(72) Inventor: Neil Appalsamy, Ajax (CA)

(73) Assignee: 4PAY INCORPORATED, Ajax (CA)

(21) Appl. No.: 14/186,614

(22) Filed: Feb. 21, 2014

Related U.S. Application Data
(60) Provisional application No. 61/767,501, filed on Feb. 21, 2013.

(51) Int. Cl. G06Q 20/38

(52) U.S. Cl. CPC G06Q 20/382
USPC 705/64

(57) ABSTRACT

The present invention includes methods for completing the secure transfer of information, such as purchase transactions, money transfers, identification transfers, loyalty point transfers and coupon transfers. The methods comprise generating, transmitting and displaying a digital challenge token as an optically readable code, to be scanned and answered. Once the answer is processed, the information is transferred.

This application claims priority to U.S. Ser. No. 61/767,501, entitled METHODS, USES AND SYSTEM FOR TRANSMITTING, CONVERTING, AND DISPLAYING A CHALLENGE TOKEN AS AN OPTICALLY READABLE CODE, filed Feb. 21, 2013, which is incorporated herein by reference.

### BACKGROUND

It has become commonplace for information exchange (e.g. financial information) transactions of all kinds to be conducted over global communications networks. Financial transactions are typically conducted on secured websites, such as those operated by financial institutions. Despite rigorous security protocols, the information exchanged during financial transactions is susceptible to theft. Several threats to information security exist including Man-in-the-browser, man-in-the-middle, key logging, session hijacking, pharming, phishing, site cloaking, cross-site scripting, OS command injection, SQL injection, cookie tampering and outbound data theft.

For example, during the purchase of goods or services from a website, a shopper typically enters user details and credit card information in order to complete a purchase. Personal computer viruses, malware and key loggers can record this information and send it to other parties.

Another example is the man in the middle, in which software is put in place that intercepts all interactions between a customer and a banking website.

In addition to online financial transaction threats, many point of sale (POS) systems today display customer checkout totals on tethered (wired) and wireless card terminals. As card terminals work independently of POS systems (locally storing daily credit card information) terminals present a security risk, since they can be stolen.

What is required is a more secure method of conducting information exchange transactions over a global communications network.

### SUMMARY

In one embodiment, the present invention is a method comprising generating and transmitting a digital challenge token as an optically readable code.

In another embodiment, the present invention is a method comprising converting a digital challenge token into an optically readable code for scanning and answering the challenge token.

In yet another embodiment, the present invention is a method comprising displaying a challenge token as an optically readable code.

In yet another embodiment, the present invention is a method comprising transmitting a challenge token as an optically readable code.

In yet another embodiment, the present invention is a use of a digital challenge token for conversion to an optically readable code.

In yet another embodiment, the present invention is a use of a digital challenge token for display as an optically readable code.

In yet another embodiment, the present invention is use of a digital challenge token as a transmittable optically readable code.

In yet another embodiment, the present invention is a network system comprising a first node to verify a personal identification number and generate a transmittable digital challenge token based on a first parameter set and in response to verification, and a second node to add a second parameter set to the digital challenge token and convert the token into a transmittable optically readable code.

In yet another embodiment, the present invention is a network system comprising a first node to verify a personal identification number and generate a transmittable digital challenge token based on a first parameter set and in response to verification, and a second node to add a second parameter set to the digital challenge token and transmit the token as an optically readable code.

In yet another embodiment, the present invention is a network system comprising a first node to verify a personal identification number and generate a transmittable digital challenge token based on a first parameter set and in response to verification, and a second node to add a second parameter set to the digital challenge token and display the token as an optically readable code.

In yet another embodiment, the present invention is a method comprising displaying a challenge token as a pictograph, for scanning and answering the challenge token.

In still yet another embodiment, the present invention is a use of a pictograph for scanning, and answering a challenge by any of text string, key pad, voice scan, retinal scan, and fingerprint input.

### DRAWINGS

FIG. 1 illustrates a purchase transaction according to the present invention.

FIG. 2 illustrates a money transfer according to the present invention.

FIG. 3 illustrates an information sharing transaction according to the present invention.

FIG. 4 illustrates coupon sharing according to the present invention.

### DESCRIPTION

The present invention includes methods for generating, converting and transmitting a digital challenge token as an optically readable code. The code may be any of a bar, quick response (QR) bar, matrix bar, Morse, Braille, alphanumeric, and universal product code. The code is intended to be scanned by a mobile device, such as a smartphone, wrist band activity tracker or tablet computer. Security algorithms, generated on remote servers, are used to produce one-time use tokens that require user personal identification number (PIN) verification to successfully process information exchange interactions. Customers register personal information, such as credit card or other payment information with the remote server, to be relayed when a digital challenge token is answered correctly. Coupons, loyalty program information and other offers may also be stored on the remote server. Tokens are used one-time and each can have a varying time-to-live (TTL) after which the token is no longer usable. Depending on requirements, the digital challenge token may be at least one of encrypted, transmitted to an optical display, transmitted to a remote display, transmitted to a global computer network website, be available for a limited time, inactivated after successful use, inactivated after a failed single use or failed multiple uses.

The generation and transmission of the token may be preceded by any of the following steps: a purchase transaction, money transfer, identification transfer, point transfer, and coupon transfer. As such, the methods described can be used for sending money, receiving money, making a deposit, making a withdrawal, making a purchase, making a donation, requesting a purchase, presenting a coupon, presenting an offer, claiming a coupon, claiming an offer, sharing a coupon, sharing an offer, sharing contact information, claiming loyalty points, and using loyalty points.

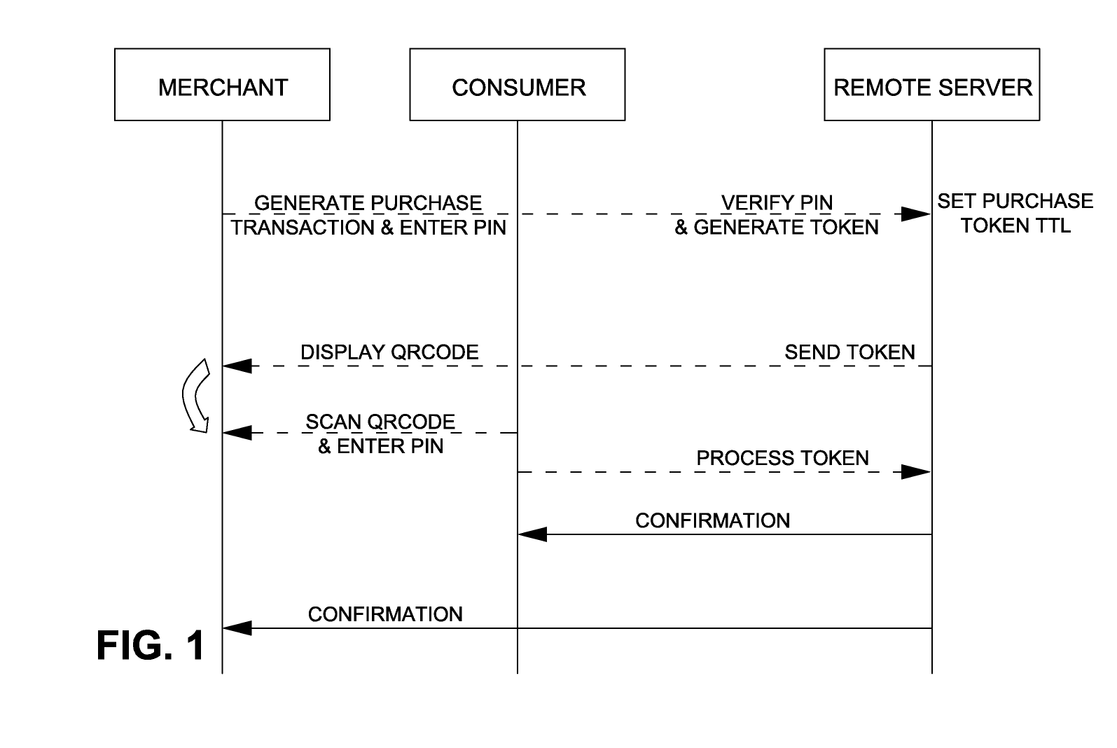

Several examples illustrate the methods. For example, as represented in FIG. 1, when a customer makes a purchase, either from a physical POS or from a merchant website, a purchase request is initiated by the merchant (by entering a PIN) or by clicking on the merchant shopping cart “checkout” button (not shown). The purchase request is sent to a dedicated remote server to generate a token. The remote server comprises at least a first node to generate a transmittable token based on a first parameter set, and at least a second node to add a second parameter set to the token. The resulting challenge token is converted and displayed as an optically readable code, such as a QR code, on the merchant's website or at the POS, to be answered by a customer.

The customer then scans the QR code using a mobile device and is presented with acceptable payment options, as well as an opportunity to provide any coupons or offers, and redeem loyalty points (based on the amount identified on the merchant shopping cart checkout screen). The customer enters selections and a PIN, which are then transmitted as an encrypted token to be verified and processed by the remote server. Once processed, responses (confirmation or failure of transaction) are sent to the customer's mobile device as well as the merchant, thereby completing the purchase transaction. This method allows for Internet and POS shopping without entering credit card information or logging into third party payment gateway sites.

Optionally, an initiator code can be displayed along with the QR code. If the customer cannot scan the QR code, the customer can bypass the scanning requirement by typing in an initiator code. The customer then inputs selections along with the customer PIN. The customer information is then transmitted as an encrypted token to be verified and processed by the remote server. Once processed, responses (confirmation or failure of transaction) are sent to customer's mobile device as well as the merchant, thereby completing the purchase transaction.

Similarly, the methods can be used to complete any of a money transfer, an identification transfer, a points transfer and a coupon transfer.

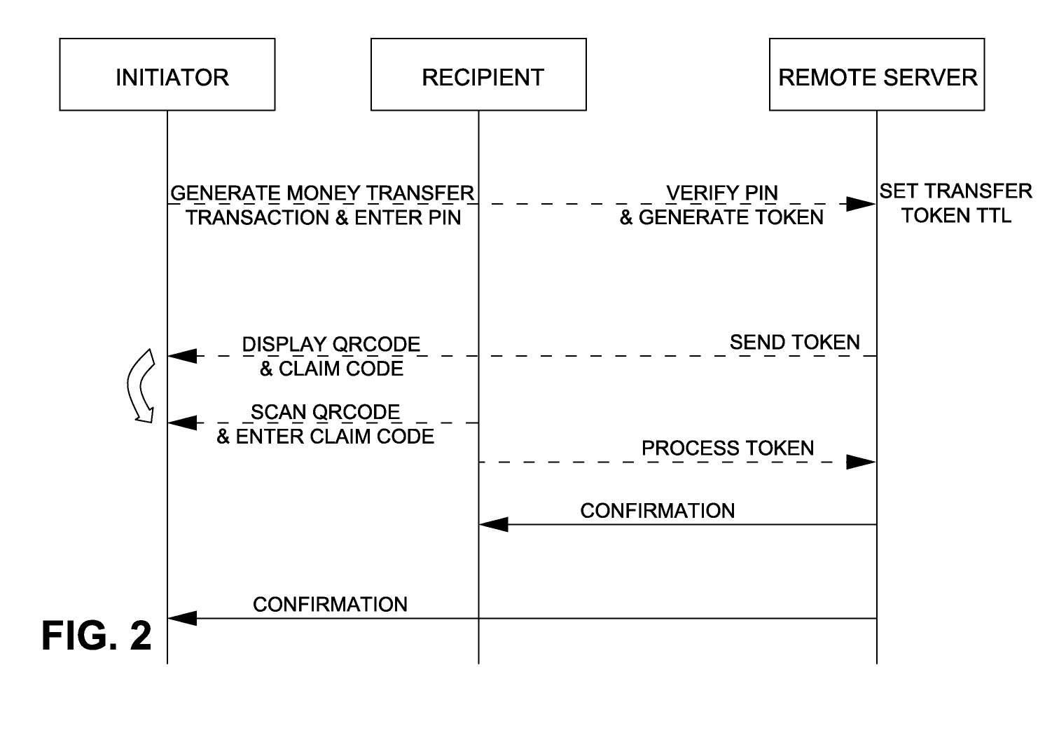

FIG. 2 shows how the method can be used to transfer money between two customers. An initiator customer generates a money transfer request and enters a PIN. The transfer request is sent to a dedicated remote server, which verifies the PIN and generates a token. The token is converted and displayed by the initiator customer as an optically readable code, along with a claim code. The QR code is scanned by recipient customer's mobile device, giving the recipient customer an opportunity to answer the challenge token by entering the claim code. The response is relayed and processed by the remote server. Once processed, confirmation is sent to the initiator customer as well as the recipient customer, and the money is transferred.

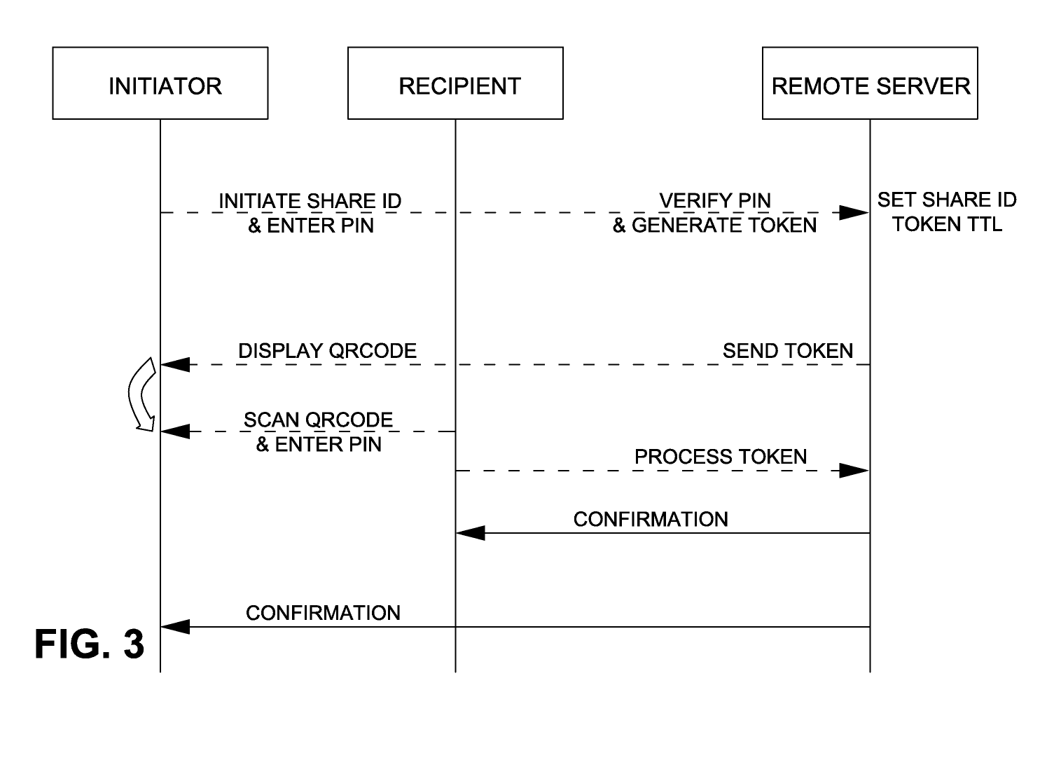

FIG. 3 shows how the method can be used to share contact information between two customers. An initiator customer generates a share identification request, and enters a PIN. The request is sent to a dedicated remote server, which verifies the PIN and generates a token. The token is converted and displayed by the initiator customer as an optically readable code, along with an initiator code. The QR code is scanned by recipient customer's mobile device. The response is relayed and processed by the remote server. Once processed, confirmation is sent to the initiator customer as well as the recipient customer and the contact information is transferred.

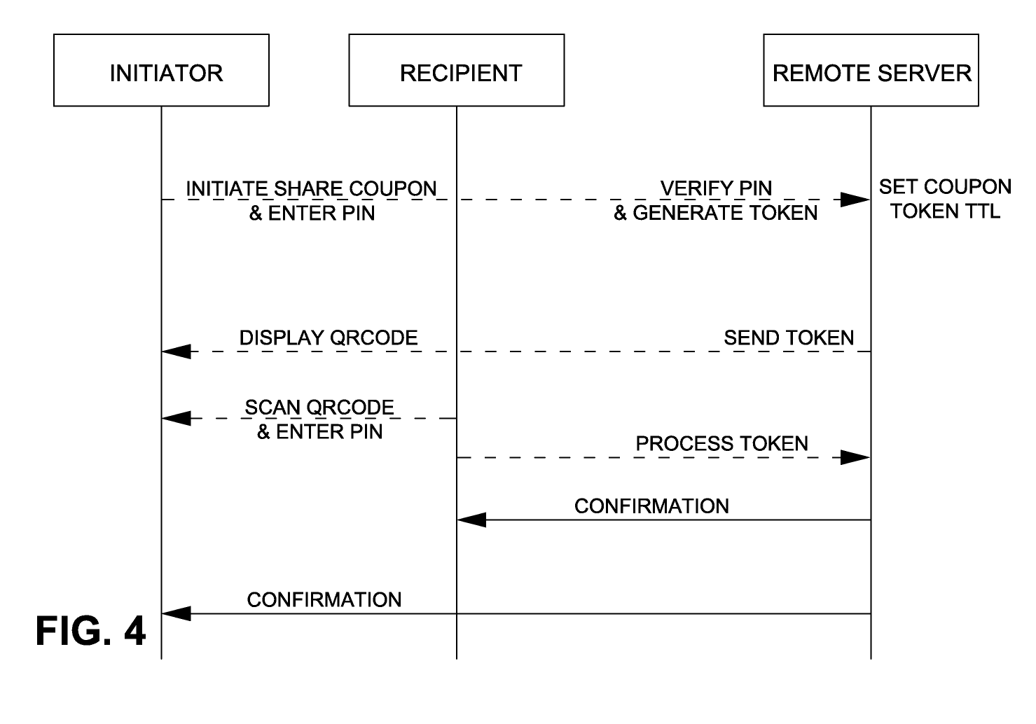

FIG. 4 shows how the method can be used to share coupons between two customers. An initiator customer generates a share coupon request and enters a PIN. The request is sent to a dedicated remote server, which verifies the PIN and generates a token based on the request. The token is converted and displayed by the initiator customer as an optically readable code, along with an initiator code. The QR code is scanned by recipient customer's mobile device, and the response is relayed and processed by the remote server. Once processed, confirmation is sent to the initiator customer as well as the recipient customer and the coupon information is transferred.

What is claimed is:

1. A method comprising generating and transmitting a digital challenge token as an optically readable code.

2. The method in claim 1 wherein the code is any of bar, quick response bar, matrix bar, Morse, Braille, alphanumeric, and universal product code.

3. The method in claim 1 further comprising a preceding step of generating any of a purchase transaction, money transfer, identification transfer, point transfer, and coupon transfer.

4. The method in claim 1 further comprising a subsequent step of any of displaying the code for challenge, scanning the code, answering the challenge token, processing an answer token, transmitting an answer token, transmitting a confirmation, completing a purchase transaction, completing a money transfer, completing an identification transfer, completing a points transfer, and completing a coupon transfer.

5. The method in claim 1 further comprising generating either of an initiator code for attachment to and display with the readable code, and a digital claim token for transmitting with the challenge token.

6. The method in claim 1 wherein the token is any of encrypted, transmitted to an optical display, transmitted to a remote display, transmitted to a global computer network web site, limited time-to-live, inactivated after any of successful and failed single use; and inactivated after any of successful and failed multiple use.

7. The method in claim 3 further comprising a subsequent step of completing any of the purchase transaction, money transfer, identification transfer, point transfer, and coupon transfer.

8. A method comprising converting a digital challenge token into an optically readable code for scanning and answering the challenge token.

9. A method comprising displaying a challenge token as an optically readable code.

10. A method comprising transmitting a challenge token as an optically readable code, to complete any of a purchase transaction, money transfer, identification transfer, point transfer, and coupon transfer.

14. A network system comprising a first node to verify a personal identification number and generate a transmittable digital challenge token based on a first parameter set and in response to verification, and a second node to add a second parameter set to the digital challenge token and convert the token into a transmittable optically readable code.

15. A network system comprising a first node to verify a personal identification number and generate a transmittable digital challenge token based on a first parameter set and in response to verification, and a second node to add a second parameter set to the digital challenge token and transmit the token as an optically readable code.

16. A network system comprising a first node to verify a personal identification number and generate a transmittable digital challenge token based on a first parameter set and in response to verification, and a second node to add a second parameter set to the digital challenge token and display the token as an optically readable code.

17. The system in claim 14 further comprising an optical display to display the code.

18. A method comprising displaying a challenge token as a pictograph, for scanning and answering the challenge token.

19. The method in claim 19 wherein the answering is by any one of text string, key pad, voice scan, retinal scan, and fingerprint scan input.

20. The method in claim 18 wherein the pictograph is any of bar, quick response bar, matrix bar, Morse, Braille, alphanumeric, and universal product code.
